(19) United States
(12) Patent Application Publication
(10) Pub. No.: US 2001/0053021 A1
(43) Pub. Date: Dec. 20, 2001

(54) Use of silicone in screens, or cameras or optical devices

(76) Inventor: Jacques Delacoux, Rueil La Gadeliere (FR)

Correspondence Address: BEEHLER & PAVITT, Suite 330, 100 Corporate Pointe, Culver City, CA, 90230, US

(21) Appl. No.: 09/886,755

(22) Filed: Jun. 20, 2001

Related U.S. Application Data
(60) Provisional application No. 60/220,632, filed on Jul. 25, 2000.

(30) Foreign Application Priority Data
Jun. 20, 2000 (FR) 00 07832

(51) Int. Cl. G03B 21/56; G03B 21/60

(52) U.S. Cl. 359/443; 359/447; 359/448; 359/452

(57) ABSTRACT

An optical device comprising a window or a viewing screen (18), a housing (24), and optical means (16) receiving radiation which penetrates into the housing by passing through the window or the screen, or producing and emitting radiation which leaves the housing by passing through the window or the screen, the device being characterized in that the housing is completely filled with silicone (20, 22).

### TECHNICAL FIELD AND PRIOR ART

The invention relates to the field of video screens, in particular monitor screens suitable for use with cameras.

It also relates to the field of cameras per se and to that of lighting systems or optical devices suitable for use on sites where films are shot.

FIG. 1 shows the conventional use of a video screen 2 coupled to a camera 4. The camera serves to view a scene and record it on a medium such as a reel of film. In many cases, it is important to have an auxiliary viewing screen 2 or video screen acting as a monitor enabling the scene that is being shot to be viewed.

FIGS. 2 and 3 are diagrams showing the outside appearance of such a video screen, and FIG. 4 shows the elements of such a screen.

In these figures, reference 6 designates the viewing window, reference 8 the housing of the video monitor, and reference 10 the connection enabling signals to be transmitted from the camera 4 to the screen 2. The screen is also provided with adjustment buttons, not shown in these figures, serving in particular to adjust the quality of the displayed image.

FIG. 4 shows the components of the screen that are housed in the housing 8: they essentially comprise signal processing cards 12 and 14, and a liquid crystal matrix 16 for forming the image on the basis of signals processed and generated by the cards 12 and 14.

Such screens are in widespread use for shooting out of doors or in a studio.

However, it is becoming more and more frequent to be able to shoot underwater, at some depth, sometimes even in undersea applications that give rise to high pressure constraints. The units presently on offer by certain manufacturers generally consist of single box machined in metal and provided with a gasket which protects the equipment from the surrounding salt water.

Such a solution is unsuitable for great depths, below 100 meters (m) to 150 m, because of the enormous compression to which the box is subjected at such depths.

The above problem is described in the context of a video screen, however it also arises with underwater video cameras and with underwater lighting equipment.

The problem also arises of being able to use video screens and/or cameras and/or lighting systems and/or optical devices in aerospace applications at high altitude or indeed in space, where there exist not only problems of decompression into a vacuum, but also problems of vibration and electrical insulation.

### SUMMARY OF THE INVENTION

The invention seeks to resolve those problems.

More precisely, the invention provides a display device comprising a viewing screen, a housing, and means for producing an image on the screen, the device being characterized in that the housing is completely filled with silicone.

The silicone present in the housing is compatible with its various components or means, and in particular with optical and electronic components or means that enable an image to be produced on the screen, and it makes it possible to offer great resistance to the high pressures encountered below a certain depth.

Furthermore, the silicone improves the resistance of the device against shock and vibration.

It is preferable to use a component whose refractive index is identical or close to that of the material used for making the window that protects the screen, thus avoiding refraction phenomena due to juxtaposing media of different indices. Also preferably, a component is selected that is transparent in the visible range, thereby optimizing the viewing of images.

It is possible to use different silicone compounds within a single housing. Under such circumstances, it is preferable behind the viewing screen to use a component whose refractive index is identical or close to that of the glass or of the viewing screen and/or having a good transmission coefficient in a determined range of wavelengths (generally in the visible) in order to maximize transmission of optical information.

In particular, for the optical portion, i.e. the portion situated immediately behind the window or the viewing screen, it is possible to use an elastomer that is solid or semi-liquid, in the form of a stabilized gel, and this can also be used for the back-lighting which serves to illuminate the matrix.

For the electronics portion, it is possible to use a liquid material having poorer optical properties, but presenting good properties for dissipating heat from said electronics portion.

The use of silicone also presents the following advantage. In a closed medium such as a hermetically sealed housing, air conducts heat very poorly to any point of the housing from which it is possible to evacuate the heat generated by operation of the device. Silicone material possesses good thermal conductivity, regardless of whether or not it is filled with additives for improving such conductivity. Thus, silicone serves to evacuate heat to the housing of the monitor which is in contact with the water in underwater applications.

The invention also applies to making an underwater camera. In which case, the camera is inserted in a housing that has a viewing window, and the entire housing is filled with silicone.

When such cameras also have mechanisms such as adjustment rings or means for focusing the lens, the silicone is selected to be liquid or semi-liquid.

The invention also applies to making a lighting device comprising a source of light, a leakproof case, and a window through which the radiation produced by the source of light can pass, and characterized in that the leakproof case is filled with silicone.

It is preferable to select a liquid silicone that withstands high temperatures.

The use of a liquid silicone facilitates maintenance of the screen or of the camera or of the lighting device.

The invention also provides an optical device comprising a viewing screen or a window, a housing, and optical components receiving radiation which penetrates into the housing by passing through the screen or the window, or that produces and emits radiation which leaves the housing by passing through the screen or the window, said device being characterized in that the housing is completely filled with silicone.

The silicone is used in a camera or a lighting device or an optical device of the invention with the same advantages as those already described above, in particular with reference to a display device.

In particular, the silicone is compatible with the various components contained in the housing of a camera or a lighting device or an optical device of the invention, and provides resistance to high pressures, in particular as encountered below a certain depth.

The invention also provides a method of shooting a film scene in which a camera of the invention is used. It is also possible to use a display device of the invention connected to the camera and enabling the scene as seen by the camera to be viewed, and/or to a lighting device of the invention, enabling the scene that is to be filmed to be lighted.

Shooting can then be performed, e.g. in an underwater environment, at a depth greater than 100 meters below the surface.

The invention also provides any underwater use of a device of the invention, in particular at a depth in excess of 100 meters below the surface.

The invention also provides a method of making an optical component, in particular a component such as a display device or a camera or a lighting device of the invention, the component comprising a viewing screen or a window, a housing, and optical components, said method comprising:

evacuating the inside of the housing by pumping; and

injecting at least one silicone compound into the housing.

The invention also provides a method of maintaining an optical device or component, in particular a component such as a display device or a camera or a lighting device of the invention, said component comprising a viewing screen or a window, a housing, and optical components, the housing being filled with silicone, and said method comprising:

a step of draining the silicone;

a maintenance or repair step;

a step of evacuating the inside of the housing by pumping; and

a step of injecting at least one silicone compound into the housing.

All of the devices described above can also be used at high altitude (in the stratosphere and above), in particular for non-pressurized applications and/or applications in space, where problems of decompression exist. Such devices are protected against the effects of depressurization at altitude due to the absence of air because the housing or the case is filled with silicone.

### BRIEF DESCRIPTION OF THE FIGURES

The characteristics and advantages of the invention appear more clearly in the light of the following description. This description relates to embodiments given by way of non-limiting explanation and it refers to accompanying drawings in which:

FIG. 1 shows a video screen mounted on a camera;

FIGS. 2 and 3 are outside views of a video screen;

FIG. 4 shows components placed inside a video screen of known type;

FIG. 5 shows a video screen structure of the invention;

FIG. 6 shows a particular feature of a video screen in accordance with the invention;

FIG. 7 shows a lighting device of the invention;

FIG. 8 shows a camera of the apparatus;

FIG. 9 shows a method of making a device of the invention;

FIG. 10 shows a method of making a video screen of the invention; and

FIGS. 11 and 12 show examples of use of the invention.

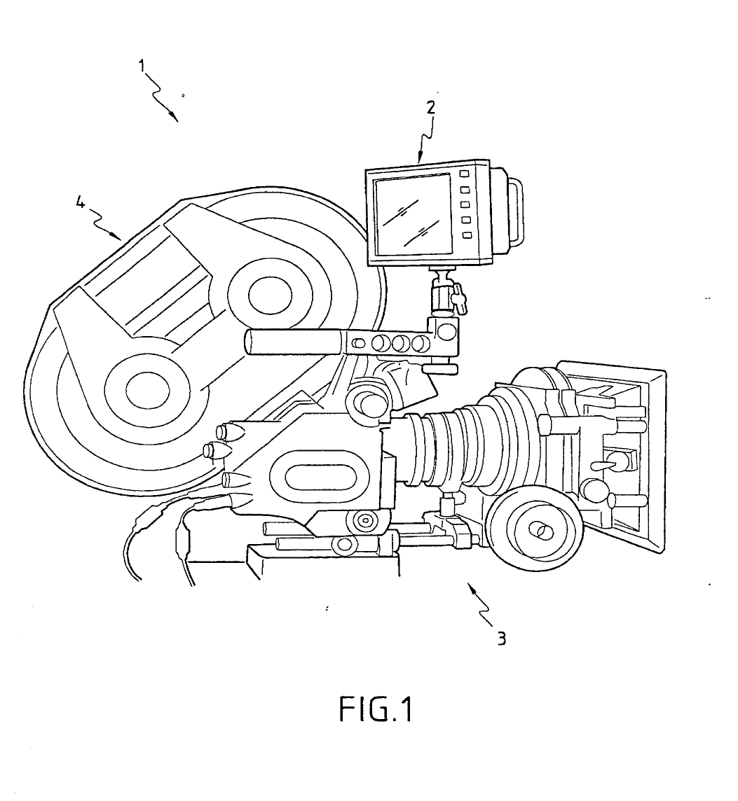

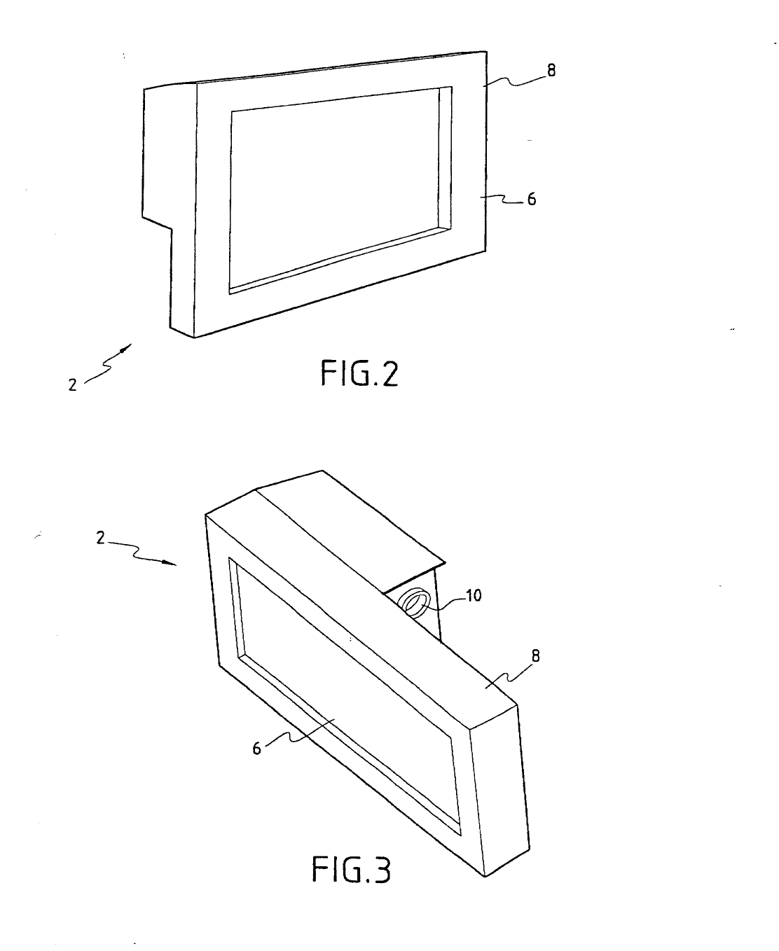

### DETAILED DESCRIPTION OF THE IMPLEMENTATION OF THE INVENTION

A first embodiment of the invention is described with reference to FIG. 5.

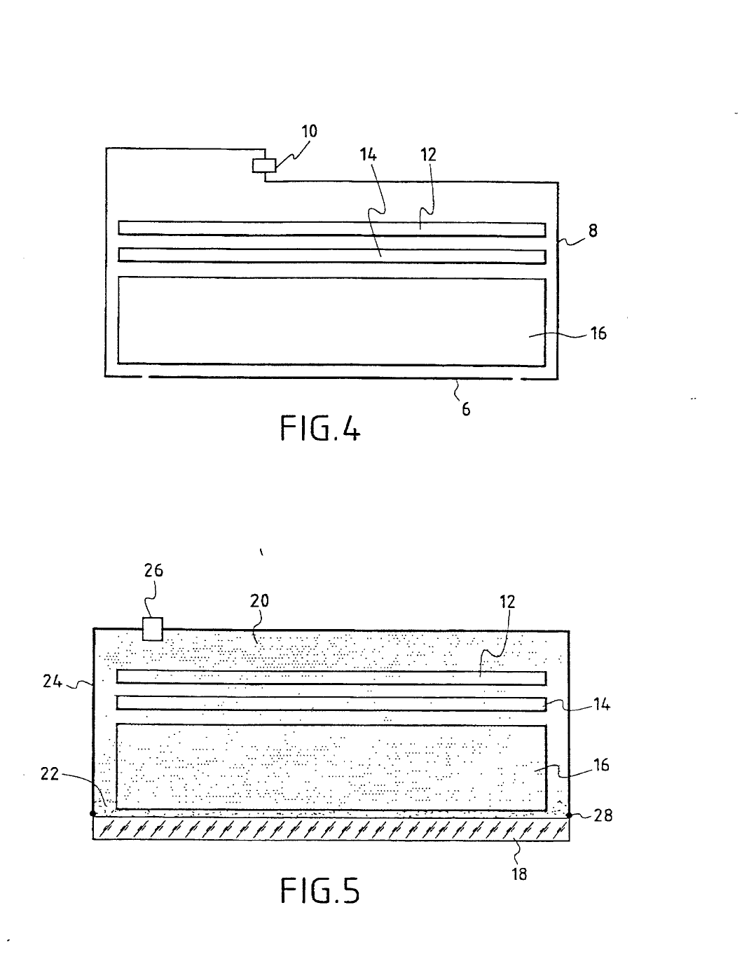

In this figure, as in FIG. 4, references 12 and 14 designate signal processing cards. Reference 16 designates a liquid crystal matrix, and reference 18 a protective glass through which an observer can view images.

The assembly is contained in a leakproof housing 24 provided with sealed electrical connection means 26.

A gasket 28 provides sealing between the protective glass 18 and the housing 24.

The inside of the housing 24 is filled with silicone. In the example shown, the front or optical portion is filled with silicone 22 in the form of a gel or an elastomer, while the electronics portion is filled with a liquid silicone 20.

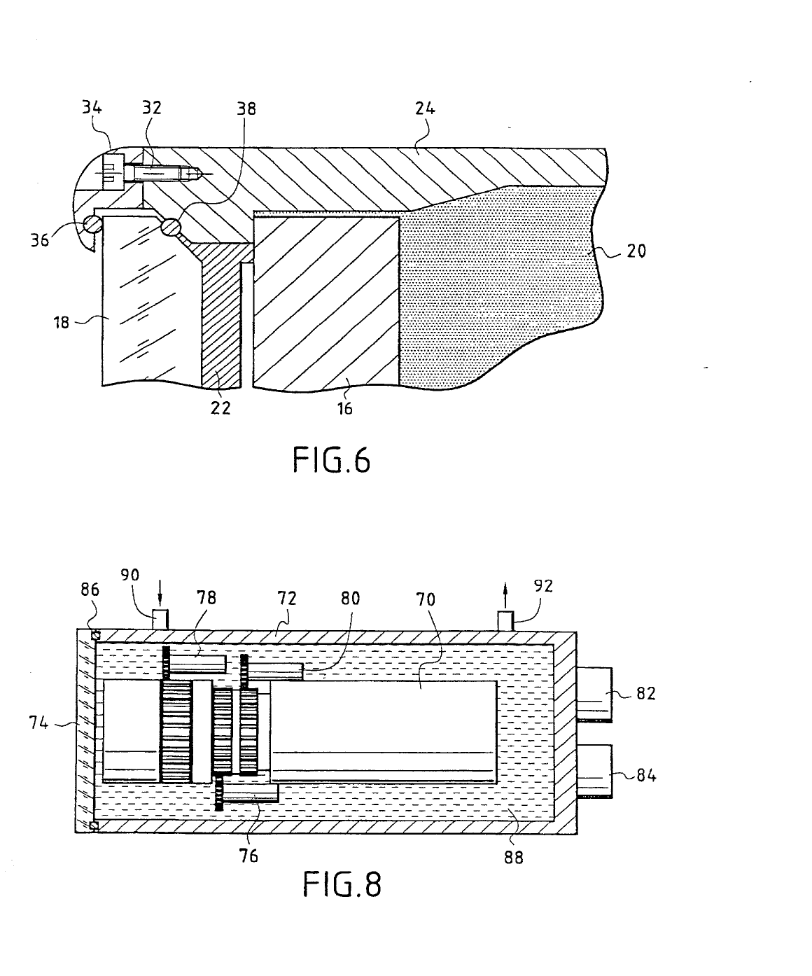

FIG. 6 shows an embodiment of the optical portion of the device. The housing 24 supports a liquid crystal matrix 16. The protective glass 18 is itself mounted between a front bezel 34 and the housing 24 by means of a screw 32. Gaskets 36 and 38 seal the device. By way of example, they are in the form of O-rings which can be compressed by tightening the assembly with the help of the screw 32. FIG. 6 shows one side of the screen, and its other side has a similar configuration.

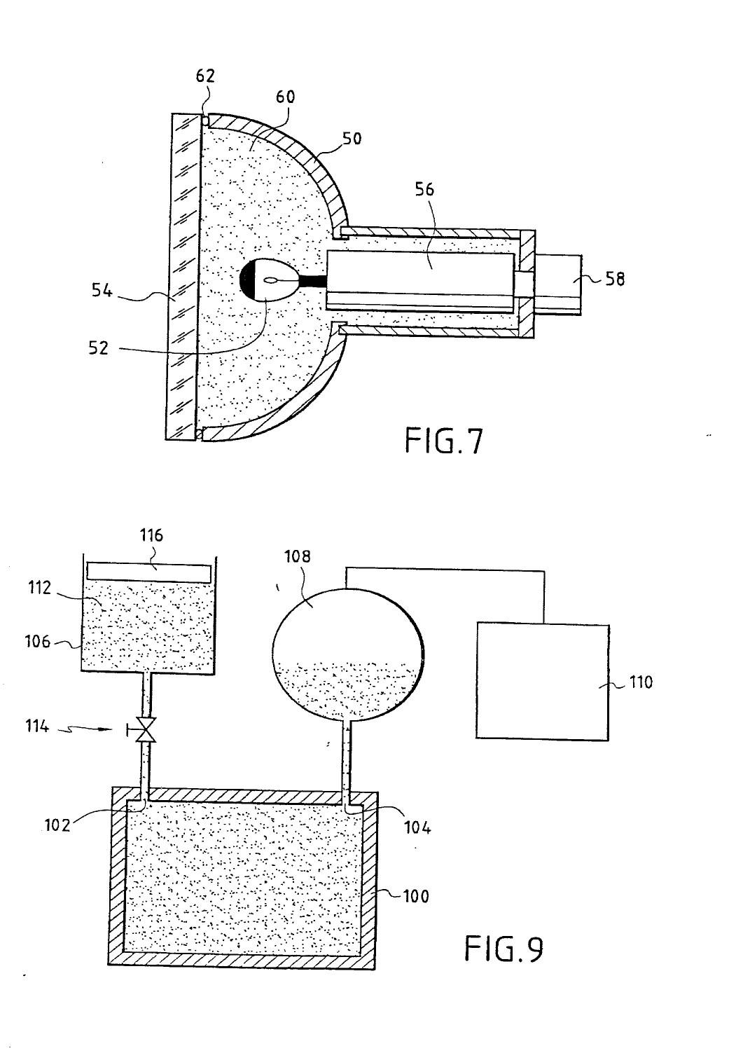

FIG. 7 shows a lighting lamp for use underwater or in a liquid environment, and comprising a bulb 52 co-operating with power adjustment means 56 to produce radiation, e.g. of the visible type. These means are mounted in a leakproof case 50 fitted with means 54 which allow at least part of the radiation produced by the means 52 to escape from the case 50. These means may be constituted by a glass 54, for example. Reference 58 designates sealed connection means enabling power to be fed to the lamp.

The inside of the case 50 is filled with a silicone 60 which preferably has properties of withstanding high temperatures (up to +260° C.: silicones exist that can be used over a range of −65° C. to +260° C.; one such product is sold by the California company NUSII). The unit as a whole is sealed by a gasket 62 placed between the means 54 and the case 50.

FIG. 8 shows an embodiment of a camera likewise intended for underwater use or for use in a liquid environment. In this figure, reference 70 designates the camera proper which is provided in this example with various motors enabling the iris of the camera to be adjusted (motor 76), or for performing a zoom function (motor 78), or for focusing (motor 80).

The unit is placed in a leakproof housing 72 provided with means 74 such as a plate of glass having optical properties that enable an external scene to be viewed over at least a certain range of electromagnetic radiation wavelengths, generally in the visible.

In FIG. 8, references 82 and 84 designate sealed connections, one for connecting the camera to a video monitor device, e.g. of the type of the invention and as described above with reference to FIGS. 5 and/or 6, and the other serving in particular to power the camera with electricity and to transmit control signals to the various motors 76, 78, and 80.

The components placed in the housing 72 are immersed in liquid silicone 88. References 90 and 92 respectively designate an inlet for injecting silicone and an outlet (drain) enabling the liquid silicone 88 to be extracted from the housing 72.

FIG. 9 is a diagram showing a method of making a component of the invention. This component, given reference 100 in FIG. 9, can be a video screen or a lamp or a camera, for example. It has two orifices 102 and 104, one of which is connected to a tank 106 of silicone and the other of which is connected to an overflow reservoir 108 and via the reservoir 108 to pump means 110 enabling the inside of the component 100 to be evacuated.

The tank 106 contains a supply of liquid silicone 112. A valve 114 serves to adjust the rate at which silicone flows into the component 100. Reference 116 designates a float on the surface of the liquid 112.

The component 100 is initially evacuated by using the pump means 110.

Once the component 100 has been evacuated, the silicone compound 112 is injected into it. The silicone compound can be in the form of an elastomer, a gel, or a liquid, as a function of the desired application.

After the component 100 has been filled, a further stage of pumping using the means 110 is performed so as to degas the silicone that has been injected.

The injected silicone or mixture is polymerized under the conditions described by the manufacturer of the compound.

It is possible with a single component 100 to perform successive injections of a plurality of silicones of different compositions and/or densities. This makes it possible, for example, to use a solid or semi-liquid elastomer in the form of a stabilized gel for an optical portion (e.g. for the portion situated between the matrix 16 and the means 18 of FIG. 5), while a liquid silicone can be used for the electronics portion that does not require any particular optical quality but that presents better heat dissipation characteristics. In addition, the use of a silicone in liquid form to protect the electronics portions facilitates any maintenance of the appliance since it is easy to empty the liquid silicone from the case containing it, to perform the desired maintenance operations, and then to refill the components using the techniques described above.

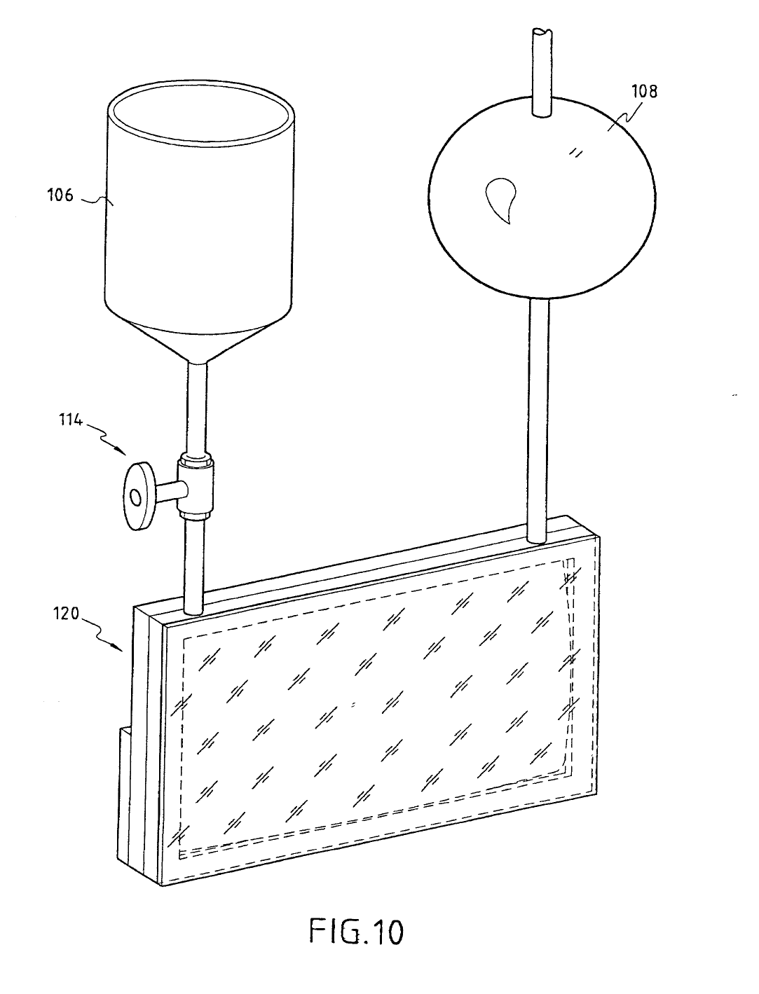

FIG. 10 shows an embodiment of a video monitor screen 120 of the invention having, for example, one of the structures described above with reference to FIGS. 5 and/or 6, and provided with the injection tank 106 and the overflow reservoir 108. The pump 110 is not shown in this figure.

Whatever embodiment of the invention is envisaged, the use of silicone presents the following advantage. Silicone is temperature stable, and it is inert, both chemically and electrically, at least over the voltage ranges used in the context of applications to shooting filmed scenes. Therefore, no special precautions need to be taken and no specific treatments need to be performed on the inside face of the housing of a component of the invention.

For components in which optical properties are important (which applies to the three devices described above: camera; lamp; and screen), it is preferable to use a silicone component having a refractive index that is identical or very close to that of the transparent portion of the housing (as referenced 18, 54, and 74 in FIGS. 5, 7, and 8), and/or a good transmission coefficient in a determined range of wavelengths (in general in the visible) so as to maximize transmission of optical information.

Furthermore, the use of a silicone compound inside the housing presented advantages from the thermal point of view. Air is a very poor conductor of heat, therefore giving rise to problems in components where a large amount of power is dissipated, as applies, for example, to the lamp described above with reference to FIG. 7. Silicone presents good thermal conductivity which can optionally be further improved by adding specific components. Silicone thus makes it possible to evacuate the heat which is produced inside the housing towards the housing of the component, with the outside of the housing being in turn in contact with water in underwater applications.

Finally, in particular with lamps such as those shown in FIG. 7, the use of a silicone in liquid form as compared with using an elastomer or a gel, makes it possible to take action easily on the inside of the component, and in particular to change the lamp 52 when it is no longer functional.

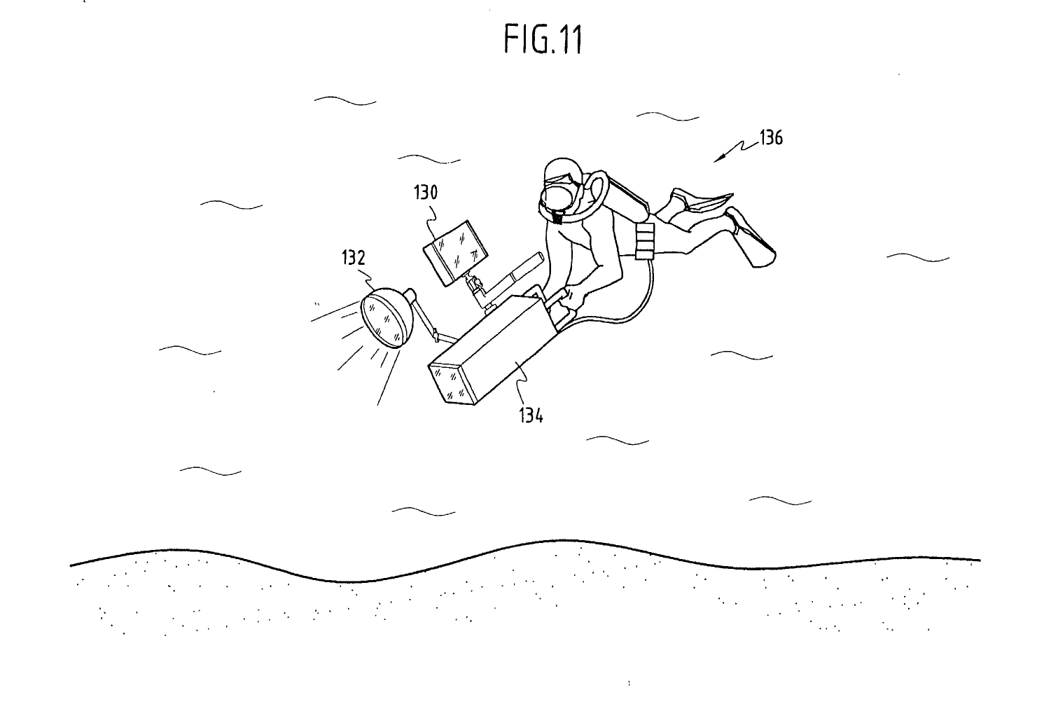

The invention is particularly suited to use in an underwater environment as shown in FIG. 11, and in particular for filming scenes with a camera 134 as described above with reference to FIG. 8, in combination with a display device 130 (video monitor) as described above with reference to FIG. 5 or 6, and with the scene being lighted, for example, by one or more spotlights or lighting devices 132 as described above with reference to FIG. 7. A diver 136 can then shoot films at depths greater than 100 meters or 150 meters.

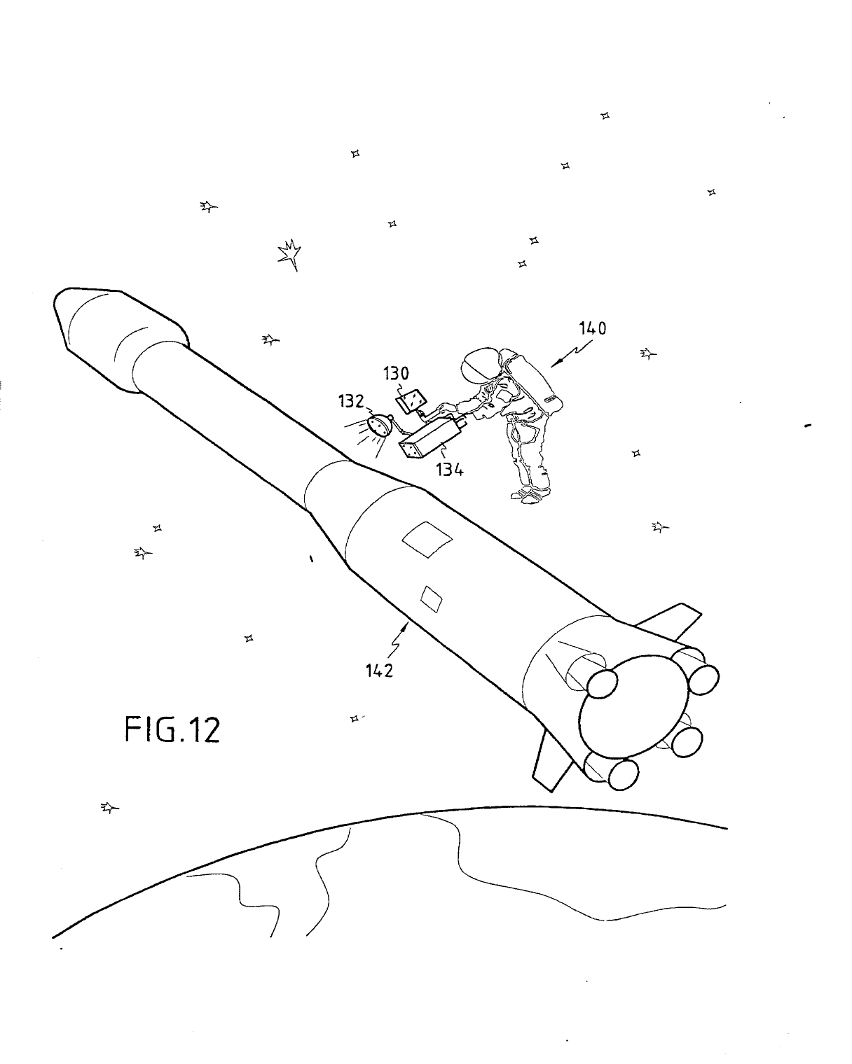

The invention is also very suitable for use in a non-pressurized medium, e.g. at high altitude in the stratosphere or above, or indeed at an altitude of more than 10 km. Use in space is shown in FIG. 12. An astronaut 140 is filming in space by means of a camera 134 of the invention, a display device 130 of the invention, and a lighting device 132 of the invention. An optical device of the invention can thus be carried on board an aircraft or a spacecraft 142 such as a space station and is then protected against any effect of depressurization at altitude because there is no air inside the enclosure or housing or envelope (the air has been replaced by silicone).

Silicone also serves to protect the electronic components from vibration and to insulate them electrically.

It is possible to use one of the above-described devices independently of the others. Thus, for example, a camera 134 can be used without a screen or a lighting device, e.g. in the sea or in space.

1. A display device comprising a viewing window (18) or a screen, a housing (24), and means (12, 14) for producing an image on the screen, the device being characterized in that the housing is completely filled with silicone (20, 22).

2. A device according to claim 1, in which the screen or the window is disposed between a front bezel (34) and the housing (24), with at least one gasket (36, 38) being disposed between the bezel and the housing.

3. A device according to claim 1 or 2, in which the silicone situated behind the screen presents a refractive index that is identical or close to that of the material constituting the screen or the window.

4. A device according to any one of claim 3, in which the silicone situated behind the screen or the window is transparent in the visible range of the spectrum.

5. A device according to claim 4, in which the silicone situated immediately behind the screen or the window is a semi-liquid or gel or elastomer silicone.

6. A device according to claim 1, in which the housing is filled with a plurality of silicone compounds.

7. A device according to claim 1, having an optical portion filled with a silicone in semi-liquid or elastomer or gel form, and an electronics portion filled with a liquid silicone.

8. A lighting device comprising a screen or a window (54), a housing (50), and means (52, 56) for producing electromagnetic radiation, the device being characterized in that the housing is completely filled with silicone (60).

9. A device according to claim 8, in which the silicone is liquid.

10. A camera comprising a viewing window (74), a housing (72), and means (70) for receiving radiation coming from outside the housing and passing through the window, the camera being characterized in that the housing is completely filled with silicone (88).

11. A camera according to claim 10, further comprising one or more motors (76, 78, 80) for controlling elements for adjusting the camera.

12. A camera according to claim 10 or 11, in which the silicone is liquid.

13. An optical device comprising a window (54, 74) or a viewing screen (18), a housing (24, 50, 72), an optical components (16, 52, 70) receiving radiation which penetrates into the housing by passing through the window or the screen, or producing and emitting radiation which leaves the housing by passing through the window or the screen, the device being characterized in that the housing is completely filled with silicone (20, 22, 60, 88).

14. A device according to claim 13, in which the silicone situated behind the window or the screen presents a refractive index that is identical or close to that of the material constituting the window or the screen.

15. A device according to claim 13 or 14, in which the silicone situated behind the window or the screen is transparent in the visible range of the spectrum.

16. A device according to claim 13 or 14, in which the silicone situated immediately behind the window or the screen is a semi-liquid or gel or elastomer silicone.

17. A device according to claim 16, in which the housing is filled with a plurality of silicone compounds.

18. A device according to claim 13 or 14, comprising an optical portion filled with a silicone in semi-liquid or elastomer or gel form, and an electronics portion filled with a liquid silicone.

19. A method of filming a scene in which a camera is used according to claim 12.

20. A method of filming according to claim 19, in which a display device according to claim 8 is used connected to the camera and enabling the scene seen by the camera to be viewed.

21. A method of filming according to claim 20 in which the scene is lighted by means of a lighting device according to claim 8.

22. A method according to claim 19 or 21, in which filming takes place in an underwater environment.

23. A method of filming according to claim 22, in which filming takes place at a depth of more than 100 meters below the surface.

24. A method according to claim 19 or 21, in which filming takes place in a non-pressurized medium.

25. A method according to claim 24, in which filming takes place in the stratosphere or beyond.

26. A method of making an optical component comprising a window (54, 74) or a viewing screen (18), a housing (24, 50, 72), and optical components (16, 52, 70), the method comprising:
evacuating the inside of the housing by pumping; and
injecting at least one silicone compound into the housing.

27. A method of maintaining a device made according to claim 26, the method comprising:
a step of draining the silicone;
a maintenance or repair step;
a step of evacuating the inside of the housing by pumping; and
a step of injecting at least one silicone compound into the housing.

28. A method according to claim 26 or 27, further comprising a pumping step for degassing the silicone after it has been injected.

29. A method according to claim 26 or 27, further comprising a step of polymerizing the silicone after it has been injected.

30. A method according to claim 26 or 27 comprising injecting a plurality of silicone compounds into the housing.
